(19) United States
(12) Patent Application Publication
(10) Pub. No.: US 2026/0302812 A1
(43) Pub. Date: Oct. 1, 2026

(54) CADDY FOR POWER TOOL BATTERY PACK CHARGERS AND RELATED ACCESSORIES

(71) Applicant: Black & Decker Inc., New Britain, CT (US)

(72) Inventors: Bradley Vanscoyk, Honey Brook, PA (US); John Kenrick Hans Fuerte, Bel Air, MD (US); Brian K. Wohltmann, Strewsbury, PA (US); Cole Macri, Forest Hill, MD (US)

(21) Appl. No.: 19/090,276

(22) Filed: Mar. 25, 2025

(51) Int. Cl. H02J 7/00; B25F 5/00; H01M 50/204; H01M 50/247; H01M 50/256; H01M 50/262

(52) U.S. Cl. CPC H02J 7/751; H01M 50/204; H01M 50/247; H01M 50/256; H01M 50/262; H02J 7/485; H02J 7/50; B25F 5/00; H01M 2220/30

(57) ABSTRACT

A caddy for power tool accessories includes a body forming a plurality of bays for at least partially receiving a battery pack charger, each bay including a set of protrusions for engaging the battery pack charger and a set of grooves for at least partially receiving a battery pack. The caddy may further include a recess in communication with a plurality of cable accesses, each cable access of the plurality of cable accesses in communication with a respective bay of the plurality of bays for facilitating passage of a charging cord associated with the battery pack charger.

### FIELD

The present application relates to the organization, coordination, and/or transportation of power tools and related accessories. In some implementations, the present application relates to a caddy for organizing, coordinating, and/or carrying accessories for power tools such as power tool battery pack chargers and associated battery packs.

### BACKGROUND

Power tools, for example, cordless power tools, include an electric motor that may be energized by a power source, such as a removable battery pack, and allow users to work in a variety of environments with reduced concerns of electrical outlet availability.

As battery packs for cordless power tools have a finite storage capacity, operating conditions may drain such battery packs leading to periodic recharging cycles during which a given battery pack is unavailable for use with one or more cordless power tools. Accordingly, coordination of charging among multiple battery packs may be employed to ensure that a sufficient number of charged battery packs are available to power a variety of cordless power tools in a working environment.

Accordingly, it would be desirable to provide for the organization, coordination, and/or transportation of battery pack chargers and associated battery packs for cordless power tools.

### SUMMARY

The present disclosure provides a transportation and storage solution for electrical chargers and battery packs in a form of a caddy or a portable organizer. An example caddy includes multiple bays for receiving multiple cup-style electrical chargers, which may be of different shapes and sizes.

According to one aspect, the disclosure is generally directed to a caddy for power tool accessories. The caddy includes a body forming a plurality of bays on a first side of the body, each bay of the plurality of bays (1) recessed along the first side of the body for at least partially receiving a battery pack charger, (2) including a set of protrusions for engaging the received battery pack charger, and (3) including a set of grooves for at least partially receiving a battery pack electrically chargeable by the battery pack charger. The caddy includes a recess formed on a second side of the body, the second side of the body opposite the first side of the body, the recess in communication with a plurality of cable accesses, each cable access of the plurality of cable accesses in communication with a respective bay of the plurality of bays for facilitating passage of a charging cord associated with the battery pack charger received in the respective bay.

In some example implementations, the set of protrusions comprises a plurality of tabs for being at least partially received in respective hanging features of the received battery pack charger for securing the received battery pack charger in the receiving bay of the plurality of bays.

In some example implementations, the set of grooves comprises a plurality of slots for receiving corresponding rails of the battery pack to secure the battery pack to a receiving bay of the plurality of bays.

In some example implementations, the caddy further includes mounting features along the second side of the body for facilitating coupling of the body to a base plate configured for engagement with a support, the mounting features comprising a plurality of fastener openings formed in the body for aligning with a plurality of fastener openings formed in the base plate.

In some example implementations, the recess on the second side of the body is arranged for at least partially receiving a power strip for being in electrical communication with the battery pack charger received in the respective bay.

In some example implementations, the caddy further includes mounting features along the second side of the body for facilitating coupling of the caddy to a support; a handle formed on the first side of the body; and a cord wrap for securing a power cable of the power strip to the body. In some example implementations, the caddy further includes at least one of a hanger and at least one opening for securing hardware to the caddy.

In some example implementations, at least one bay of the plurality of bays includes a slot opening for receiving a mobile electronic device and a cable passthrough for accommodating a charging cable for the mobile electronic device.

According to another aspect, the disclosure is generally directed to a portable charging system for battery packs, the portable charging system comprising: a body forming a plurality of bays on a first side of the body, each bay of the plurality of bays (1) recessed along the first side of the body for at least partially receiving a battery pack charger, (2) including a set of protrusions for engaging the battery pack charger, and (3) including a set of grooves for receiving a battery pack electrically chargeable by the battery pack charger. The portable charging system further comprises a recess formed on a second side of the body, the second side of the body opposite the first side of the body, the recess in communication with a plurality of cable accesses, each cable access of the plurality of cable accesses in communication with a respective bay of the plurality of bays for facilitating passage of a charging cord associated with the battery pack charger, the recess on the second side of the body is sized to accommodate a power strip for being in electrical communication with each received battery pack charger, the body having a side slot along the second slide for receiving a power cord of the power strip.

In some example implementations, the set of protrusions comprises a plurality of tabs for being at least partially received in respective hanging features of the battery pack charger for securing the battery pack charger in a receiving bay of the plurality of bays.

In some example implementations, the set of grooves are configured for receiving corresponding rails in the battery pack to secure the battery pack to a receiving bay of the plurality of bays.

In some example implementations, the portable charging system further includes mounting features along the second side of the body for facilitating coupling of the portable charging system to a support.

In some example implementations, the mounting features are configured for coupling the body to a base plate configured for engagement with the support, the mounting features comprising a plurality of fastener openings formed in the body for aligning with a plurality of fastener openings formed in the base plate.

According to another aspect, the disclosure is generally directed to a mountable battery pack organizer, comprising: a body forming a plurality of bays on a first side of the body, each bay of the plurality of bays (1) recessed along the first side of the body for at least partially receiving a battery pack charger (2) including a set of protrusions for engaging the received battery pack charger, and (3) including a set of grooves for receiving a battery pack chargeable by the battery pack charger.

In some example implementations, the set of grooves are configured for receiving corresponding rails in the battery pack to secure the battery pack to a receiving bay of the plurality of bays.

In some example implementations, the set of protrusions comprises a plurality of tabs for being at least partially received in a hanging feature of the received battery pack charger for securing the battery pack charger in the receiving bay of the plurality of bays.

In some example implementations, the mountable battery pack organizer further comprises a recess in communication with a plurality of cable accesses, each cable access of the plurality of cable accesses in communication with a respective bay of the plurality of bays for facilitating passage of a charging cord associated with the battery pack charger received in the respective bay, each cable access of the plurality of cable accesses is sized to accommodate a charging cord of the battery pack charger to be received in a corresponding bay of the plurality of bays, the recess on the second side of the body arranged for at least partially receiving a power strip for being in electrical communication with the respective battery pack charger.

In some example implementations, the mountable battery pack organizer further comprises: mounting features along the second side of the body for facilitating coupling of the mountable battery pack organizer to a support; a handle formed on the first side of the body; and a cord wrap for securing a power cable of the power strip to the body.

In some example implementations, at least one bay of the plurality of bays includes a slot opening for receiving a mobile electronic device and a cable passthrough for accommodating a charging cable for the mobile electronic device.

In some example implementations, each bay of the plurality of bays is shaped for receiving the battery pack charger being selected from a set of multiple differently-configured battery pack chargers.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a left side isometric view of a caddy for battery pack chargers and related accessories according to an example embodiment of the present disclosure.

FIG. 2 is an upper isometric view of the caddy of FIG. 1, with a base plate of the caddy removed for clarity of illustration.

FIG. 3 is another left side isometric view of the caddy of FIG. 1.

FIG. 4 is another upper isometric view of the caddy of FIG. 1, with the base plate removed.

FIG. 5 is a top plan view of the caddy of FIG. 1, with the base plate removed.

FIG. 6 is a left side elevation view of the caddy of FIG. 1, with the base plate removed.

FIG. 7 is a right side elevation view of the caddy of FIG. 1, with the base plate removed.

FIG. 8 is a bottom plan view of the caddy of FIG. 1, with the base plate removed.

FIG. 9 is a front elevation view of the caddy of FIG. 1.

FIG. 10 is a rear elevation view of the caddy of FIG. 1.

FIG. 11 is another upper isometric view of the caddy of FIG. 1, with the base plate removed.

FIG. 12 is an enlarged isometric view of the bay of the caddy indicated by the area of detail A of FIG. 1.

FIG. 13 is a bottom isometric view of the caddy of FIG. 1, with the base plate removed.

FIG. 14 is a top isometric view of the caddy of FIG. 1 supporting multiple battery pack chargers.

FIG. 15 is a right side elevation view of the caddy of FIG. 1 supporting multiple battery pack chargers.

FIG. 16 is a bottom plan of the caddy of FIG. 1 receiving a power strip and with the base plate removed.

FIG. 17 is an isometric view of a portion of an example embodiment of a battery pack charger as shown in FIG. 14.

FIG. 18 is another isometric view of a portion of the battery pack charger of FIG. 17.

FIG. 19 is an isometric view of an example power tool battery pack suitable for use with the caddy of FIG. 1.

FIG. 20 is another isometric view of the power tool battery pack of FIG. 19.

FIG. 21 is an isometric view of the caddy of FIG. 1 supporting multiple power tool battery packs and battery pack chargers and mounted to a supporting structure.

FIG. 22 is an isometric view of the caddy of FIG. 1 supporting different types of battery pack chargers.

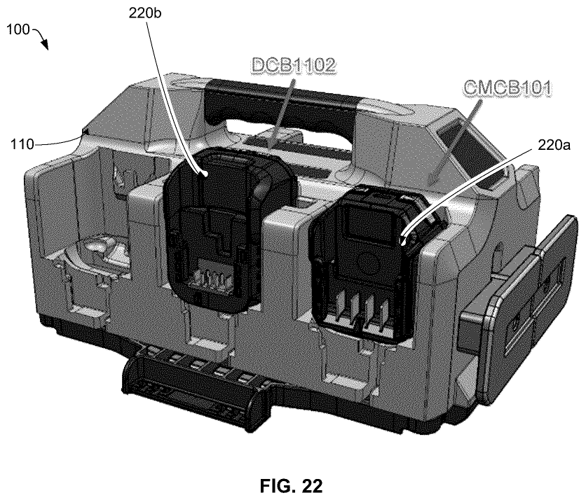

FIG. 23 is a bottom view of the caddy of FIG. 1 receiving the power strip, with the battery pack chargers inserted and charging cords grouped.

FIG. 24 is a bottom view of the caddy and power strip of FIG. 23, with the charging cords organized.

Corresponding parts are designated by corresponding reference numbers throughout the drawings.

### DETAILED DESCRIPTION

Power tools may be part of a set of power tools that may have common features, for example, a battery pack interface thereof, such that power tool battery packs and/or components and features of the power tool(s) may be interchangeably used with other power tools in the set. Such tools may include impact drills, reciprocating saws, circular saws, hammer drills, fastener drivers, sanders, etc.

In this regard, working environments may employ a number of like or different power tools that may use a number of battery packs. Additionally, a given power tool may use multiple battery packs over the course of continued operation, for example, through replacement of a drained battery pack with a charged battery pack.

Such battery packs may be placed in electrical communication with internal electrical components of the power tool, (e.g., through one or more wires, terminals, contacts, circuit boards, connectors, and control electronics) such that electrical power from the battery pack may be supplied to the power tool to drive a tool head, tool adapter, etc. In some embodiments, the battery pack may include a plurality of battery cells composed of, for example, Li-ion, lithium-ion phosphate (LPF), and/or another suitable cell chemistry. In some embodiments, the battery pack may be provided with a rated voltage, such as 12V, 18V, 20V, 24V, 54V, 60V, etc.

Battery pack chargers, may be used with one or more power tools for charging one or more of such battery packs. As a given number of battery packs associated with a power tool or multiple power tools increases, a corresponding increase in the number of battery pack chargers that may be used may increase. For example, when multiple power tools in a set are designated for use across a working environment and/or one or more of such power tools are planned for operating times beyond that supported by a single battery pack, an increasing number of battery packs and battery pack chargers may be called for. However, tracking, organizing, and using multiple battery pack chargers in tandem may become challenging, implicating space and organization concerns, competition for limited numbers of charging outlets, and lack of ease in moving such chargers from point to point, to name a few.

Example embodiments of a caddy for organizing, coordinating, and/or carrying battery pack chargers and battery packs are disclosed herein. The caddies disclosed herein include multiple receptacles or bays for holding a respective number of battery pack chargers, such as cup-type chargers. Example caddies disclosed herein enable neat organization of multiple cup-type chargers and battery packs for ease of carrying around a work site. Furthermore, example caddies disclosed herein may provide for supplying electrical power to multiple battery pack chargers through a common power cord to facilitate simultaneous charging of multiple battery packs while obviating the need to plug individual battery pack chargers into separate wall outlets or other power sources.

Further still, the receptacles or bays of the example caddies disclosed herein may be configured to support battery pack chargers having different form factors and different charger interfaces that operate with, associated battery packs, and other power tool accessories from different systems. In other words, the caddy may have a first bay that may receive a first battery pack charger of a first system that operates with a first battery pack of the first system, the first battery pack charger and the first battery pack having a first interface to enable the first battery pack charger to operate with the first battery pack and may have a second bay that may receive a second battery pack charger of a second system that operates with a second battery pack of the second system, the second battery pack charger and the second battery pack having a second interface to enable the second battery pack charger to operate with the second battery pack, wherein the first interface is different than the second interface.

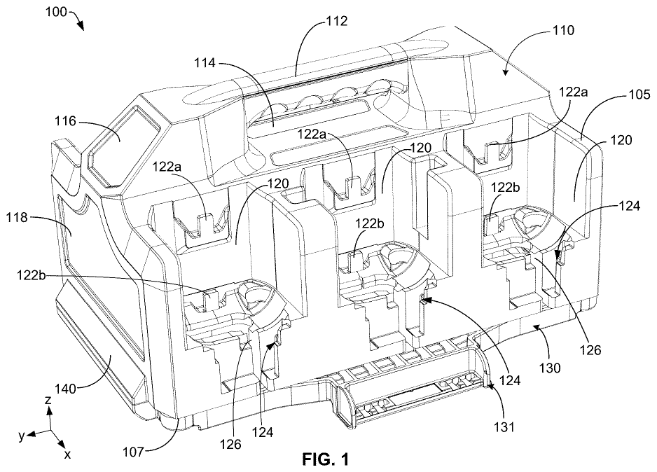

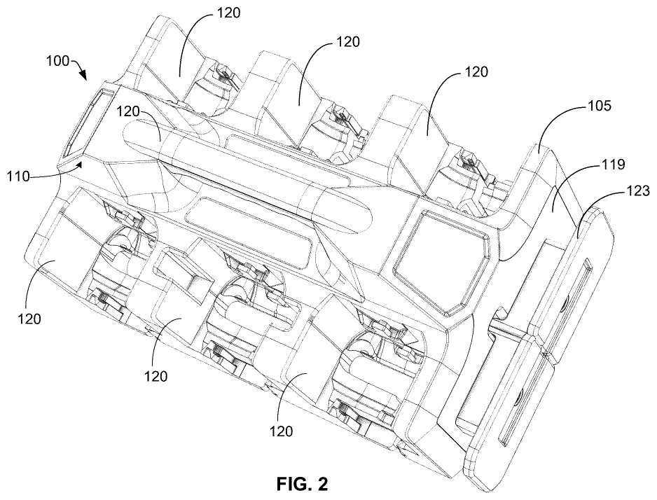

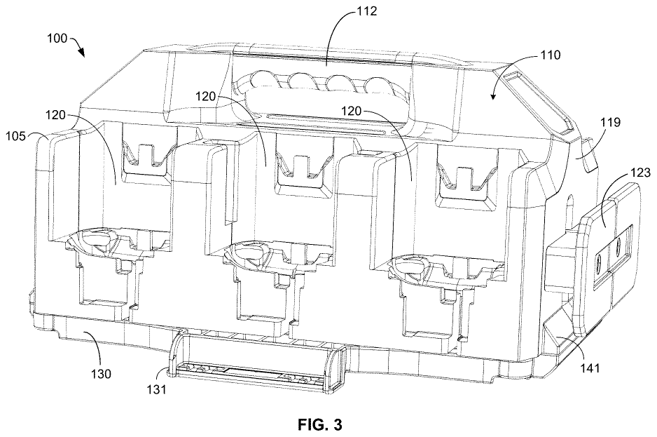

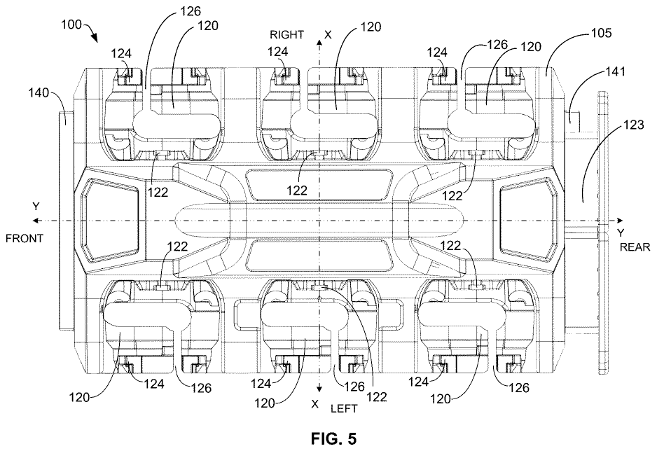

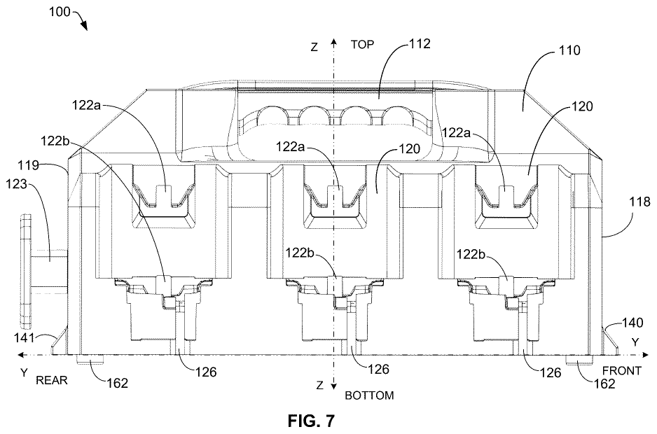

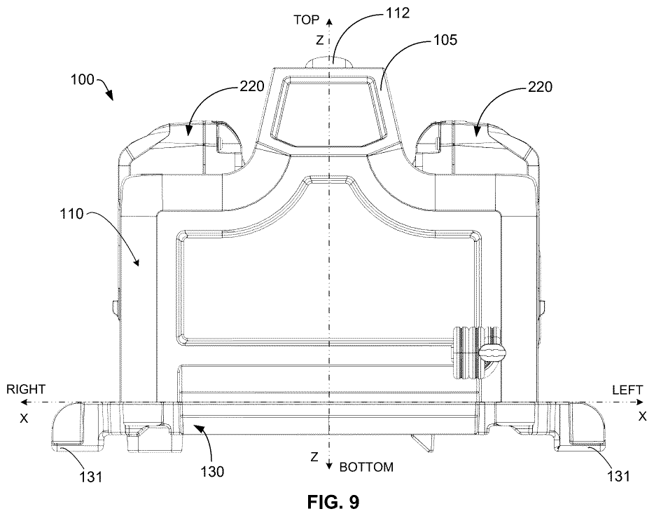

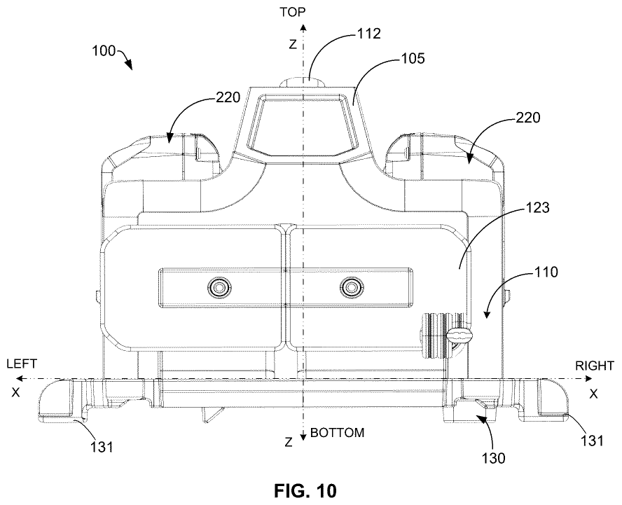

FIG. 1 illustrates an isometric view of an example embodiment of a caddy 100 for battery pack charger organization, transportation, and/or coordination. FIGS. 2-13 illustrate the caddy 100 at different orientations and view angles. FIGS. 1, 3, 9, and 10 illustrate the caddy 100 having a removable, optional, mounting plate or base plate 130 mounted thereon.

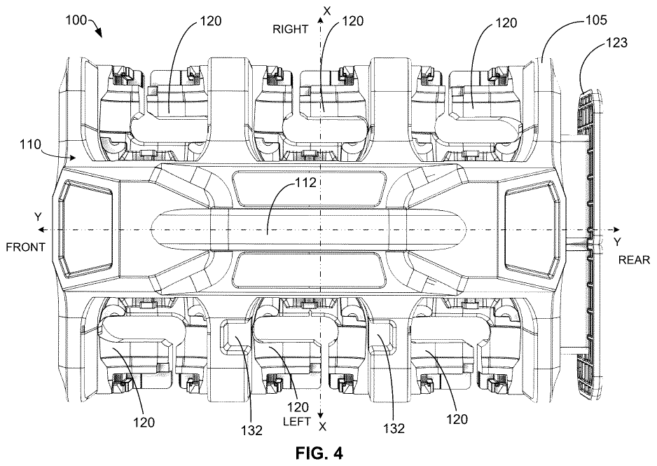

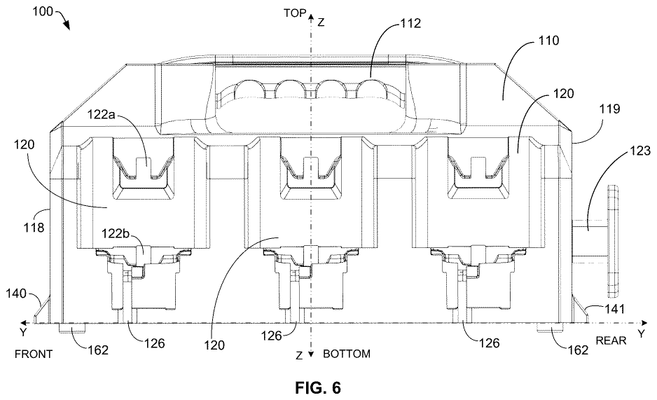

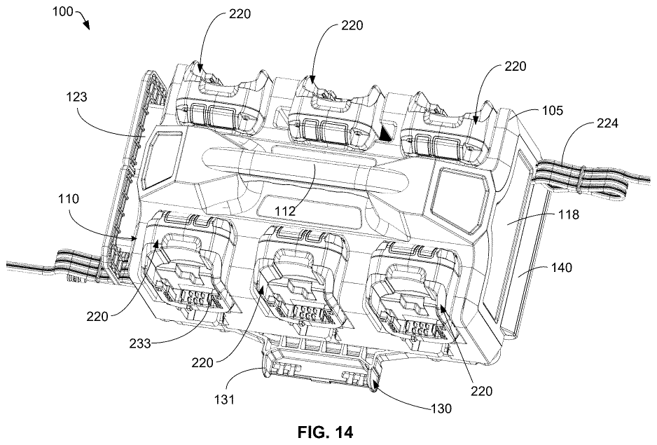

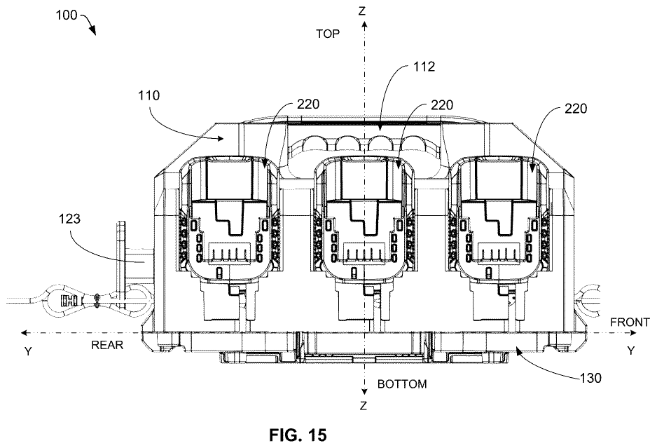

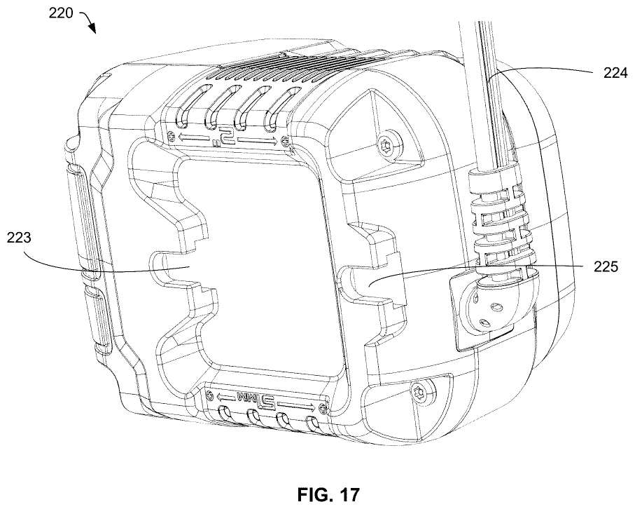

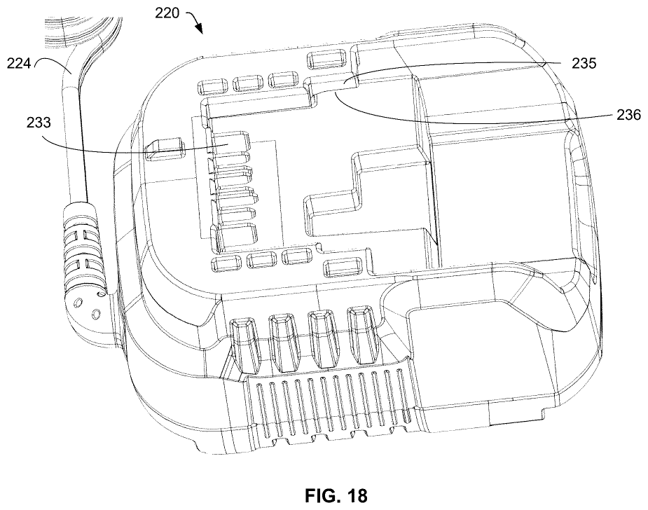

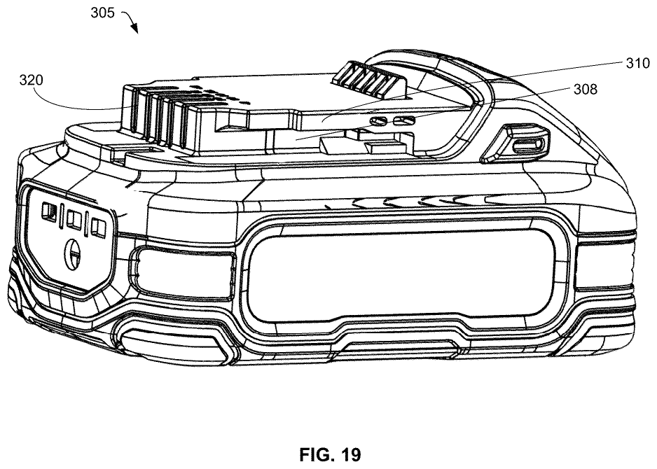

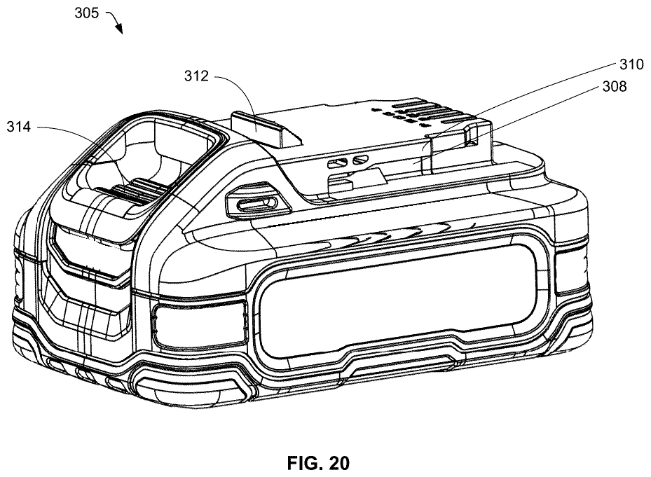

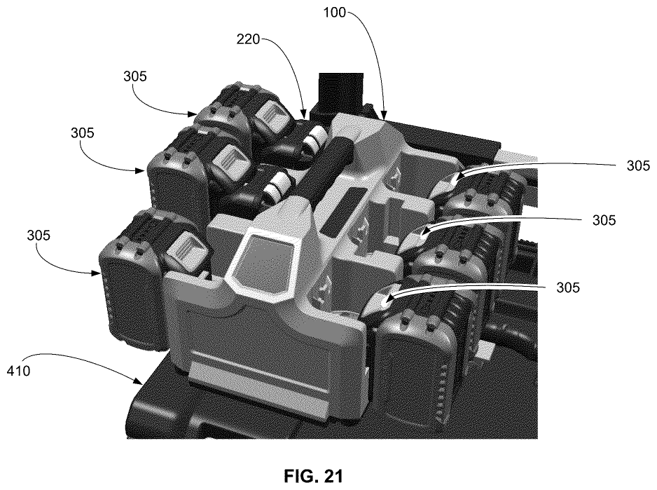

As described herein, the caddy 100 may be oriented about three axes: an X-axis, a Y-axis, and a Z-axis. Referring to FIGS. 4-5 and 8-10, the X-axis defines the caddy 100 generally in left and right directions. Referring to FIGS. 4-8, the Y-axis defines the caddy 100 generally in front and rear directions. Referring to FIGS. 6-7 and 9-10, the Z-axis defines the caddy 100 generally in up/top and down/bottom directions. FIGS. 14-16 illustrate different view of the caddy 100 carrying battery pack chargers 220 and a power strip 165. FIGS. 17-18 illustrate an example battery pack charger 220 to be used with the caddy 100. FIGS. 19-20 illustrate an example battery pack 305 compatible with the battery pack charger 220 and securable onto the caddy 100, as shown in FIG. 21.

In the aforementioned arrangement, the X-axis is perpendicular to each of the Y-axis and the Z-axis, the Y-axis is perpendicular to each of the X-axis and the Z-axis, and the Z-axis is perpendicular to each of the X-axis and the Y-axis. A first (XY) plane may be formed by the X-axis and the Y-axis. A second (YZ) plane may be formed by the Y-axis and the Z-axis. A third (XZ) plane may be formed by the X-axis and the Z-axis. It will be understood that the caddy 100 may be differently oriented with respect to a set of coordinate axes.

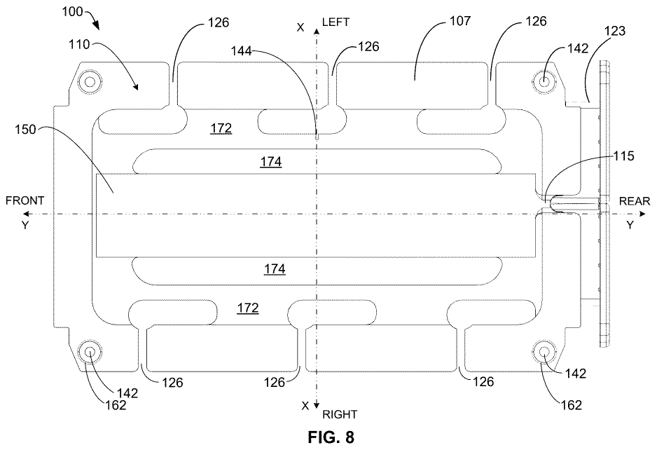

As shown, the caddy 100 includes a body 110, which includes an upper side 105 (also referred to as a first side or a top side) and a lower side 107 (FIG. 8, also referred to as a second side, or a bottom side). The caddy 100 may optionally include the base plate 130 that may be removably coupled to the body 110 for mounting the caddy 100 onto tool boxes, crates, or supports. In this regard, in some embodiments, the body 110 of the caddy 100 may be an upper body 110 of the caddy 100 that is coupled to the base plate 130 to form the caddy 100.

The caddy 100 includes multiple bays 120 recessed along the upper side 105 of the body 110 so as to extend at least partially toward the lower side 107 of the body 110. As described herein, the bays 120 may be configured to at least partially receive battery pack chargers of various configurations, battery packs, and/or other power tool accessories or related hardware. In this regard, the caddy 100 may be a caddy for power tool accessories, a portable charging system, and a mountable power tool battery pack organizer.

In some embodiments, the body 110 of the caddy 100 may be made of a polymeric material, for example, a plastic material. Such material may be injection molded, blow molded, etc.

The body 110 may be integrally formed from a single generally continuous piece of material, though it will be understood that the body 110 may be assembled by coupling two or more pieces, sections, segments, etc. together without departing from the disclosure. In some embodiments, the body 110 is made of polypropylene, polycarbonate/acrylonitrile butadiene styrene (PC-ABS), or other lightweight and durable materials. The body 110 may be formed in an injection molding process.

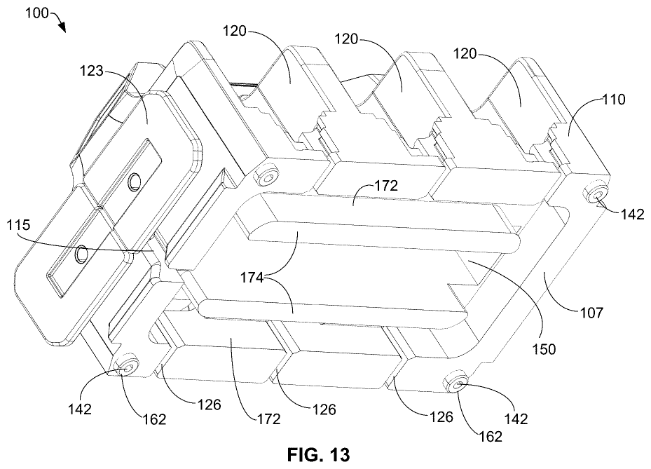

The second side 107 of the body 110 may be configured to couple to the base plate 130. The base plate 130 is secured to the second side 107 of the body 110 using multiple fasteners (e.g., screws) fastened into the multiple fastener openings 142 (seen in FIG. 13). In some embodiments, the body 110 could be coupled to the base plate 130 through additional or alternative structure, such as a snap fit or tab-and-slot arrangement.

As described further herein, the base plate 130 may be compatible with storage solutions such that the base plate 130 may provide an interface for mounting the caddy 100 onto supports such as transportation cases, carts, boxes, crates, etc. As shown in FIGS. 1, 3, 9, and 10, the base plate 130 includes a pair of protrusions 131 that may be clamped down and secured to a top of compatible storage system. As described herein, one or more of the base plate 130 and the fastener openings 142 and associated features may be mounting features of the caddy 100.

In the illustrated example embodiment, the caddy 100 includes two opposing end walls 118, 119, respectively, including a respective foot 140, 141 protruding from a bottom portion thereof, which may be aligned with a corresponding profile of the base plate 130 to provide gripping features for the ease of lifting by hands (e.g., so as to form handle features on the end walls 118, 119 of the caddy 100). In some embodiments, the end walls 118, 119 may also be shaped for storage purposes, for example, provided with recesses, compartments, etc.

In the illustrated example embodiment, the caddy 100 includes six bays 120 arranged in a two by three rectangular array on the periphery of the body 110. In some embodiments, the number of bays 120 and the arrangement may be different. For example, the caddy 100 may include a two by two square array, a two by four rectangular array, or a different arrangement. In some cases, the bays 120 may be fully enclosed by a side wall instead of being exposed along the periphery of the body 110.

In some example implementations, the bays 120 may be configured or made with different shape profiles to accommodate battery pack chargers of correspondingly different profiles, and may also be configured to receive items other than battery pack chargers. In this regard, the bays 120 may be configured with dimensions corresponding to a largest item of a variety of items contemplated to be held therein.

For example, in some embodiments, one or more of the bays 120 may be configured to hold a beverage cup, such as a tumbler or mug, a flashlight, a tape measure, a leveling tool, a case for bit drivers, etc. As such, the number, the pattern of arrangement, and the specific geometry profile of the bays 120 may be altered from the example caddy 100 shown in FIG. 1, depending on specific use scenarios.

In some embodiments, the arrangement of bays 120 along the body 110 may be such that one or more bays 120 are at least partially recessed within one or both of the end walls 118, 119.

As shown in FIGS. 1 and 2, the caddy 100 includes handle features that may include a handle 112 for ease of transportation and handling. One or more storage compartments 114 may be formed from the space below the handle 112 without interfering with the bays 120. As shown in the example caddy 100, the handle 112 may extend to both longitudinal ends (e.g., the front end wall 118 and the rear end wall 119) of the body 110 in a shape that fits a user's hand and distributes the carrying loads relatively evenly (e.g., without apparent stress concentration due to sharp corners). The handle 112 may be integrally formed along the upper side 105 of the body 110, or the handle 112 may be coupled to the body 110.

As shown in FIGS. 8 and 13, the caddy 100 further includes a recess 150 formed on the second side 107 of the body 110, the second side 107 of the body 110 opposite the first side 105 of the body 110. The recess 150 includes a cable access 126 for each of the plurality of bays 120 as shown in FIGS. 6-8. Accordingly, each cable access 126 is in communication with both of a respective bay 120 and the recess 150.

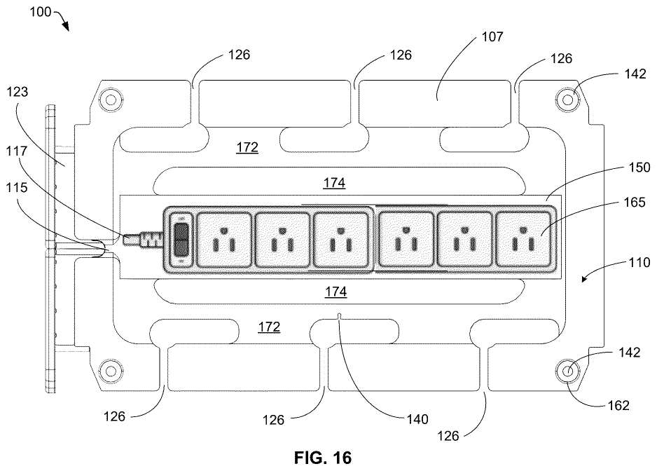

The recess 150 may accommodate at least a power strip (such as a power strip 165 as illustrated in FIG. 16). As shown in FIG. 13, the recess 150 is formed between two inner separation walls 174 on the second side 107 of the body 110.

The separation walls 174 may be arranged to form cord organizing spaces 172 along the second side 107 of the body 110 adjacent the recess 150 to accommodate power cords of the battery pack chargers 220. The body 110 may further include a side slot 115 in communication with the recess 150 to facilitate passage of a power cord 117 of the power strip 165 therethrough.

The power cord 117 may be organized using a cord holder 123 as shown in FIGS. 2-8. In some embodiments, the cord holder 123 may be a flanged member coupled to the body 110 such that a power cord associated with the power strip 165 may be at least partially wrapped therearound or otherwise positioned between the cord holder 123 and the body 110. In some embodiments, the cord holder 123 may be integrally formed with the body 110.

The second side 107 of the body 110 may also include the multiple fastener openings 142 for mounting or installing the base plate 130. The fastener openings 142 may include a rounded protrusion 162 for alignment with the base plate 130. The space inside the body 110 and enclosed by the base plate 130, e.g., the cord organizing spaces 172, may be used to organize charging cords 224 associated with battery pack chargers 220 placed into the bays 120, as described further herein.

With particular reference to FIGS. 1-7, 11, and 12, features of the bays 120 are described in detail. Because cordless power tool battery packs may vary in configuration across different brands and generations, the bays 120 may be recessed in a general ovoid shape that may enclose different battery pack chargers. For example, different cup-style battery pack chargers such as the DeWalt™ DCB1102 (available from The DeWalt Industrial Tool Company of Towson, MD) and the Craftsman™ CMCB101 (available from Craftsman.com as part of the CMCB2046-CK kit) may be fitted into the bays 120, though other battery pack charger configurations are contemplated without departing from the disclosure.

As shown, each bay 120 may be provided with a set of protrusions 122 that includes tabs 122a and 122b. Either one or both of the tabs 122a and 122b may be inserted into respective corresponding features in a battery pack charger, as described further herein. For example, some battery pack chargers may include built-in mounting features or hanging features (e.g., keyhole slots or screw mounts, as described below with reference to FIG. 17) for directly hanging the battery pack charger on a wall or pegboard storage. The tabs 122a and 122b are positioned extending at least partially upwardly and/or outwardly in the respective bays 120 and may be correspondingly sized to mate with the built-in mounting features and frictionally secure a battery pack charger in a respective bay 120 to the caddy 100. In some embodiments, the protrusions 122 could be configured for engaging portions of a power tool battery pack.

Though illustrated as rectangular tabs, the tabs 122a and 122b may have different shapes such as in oblong, trapezoid, or triangular shapes, sized for a tight fit with mounting features of the battery pack charger. It will be understood that a different number, arrangement, and/or configuration of tabs could be provided in the bays 120 without departing from the disclosure.

As described further herein, each of the bays 120 may also include a pair of grooves 124 in the body 110 for receiving corresponding rails of a battery pack. The grooves 124 may be generally positioned forwardly of the tabs 122a, 122b toward the periphery of the respective bay 120/body 110, though a different arrangement could be provided without departing from the disclosure.

With reference to FIGS. 17 and 18, an example battery pack charger 220 suitable for use with the caddy 100 is illustrated. The battery pack charger 220 is configured for being received in a respective bay 120 of the caddy 100, and has a contour that fits with the recessed profile of the bays 120.

The example battery pack charger 220 shown includes a first mounting feature/recess 223 and a second mounting recess 225. The first mounting recess 223 and the second mounting recess 225 may be notched or otherwise shaped features of the battery pack charger 220 that are configured to receive corresponding mounting hardware, e.g., screws or other hardware for coupling the battery pack charger 220 to a wall or other support. The battery pack charger 220 may include a charger interface for being electromechanically coupled with a battery pack. The charger interface may include a plurality of charger terminals 233 configured to electromechanically mate with a corresponding plurality of battery pack terminals of the battery pack and a pair of rails 235 forming a pair of grooves 236 configured to receive corresponding rails of the battery pack. The charger 220 may also include a charging cord 224 of the battery pack charger 220 may be provided for placing the battery pack charger 220 in electrical communication with a power source, e.g., a wall outlet, or an intermediary electrical connector to a power source, e.g., a power strip.

Accordingly, with reference to FIGS. 14-16, the battery pack charger 220 may be positioned in a respective bay 120 of the caddy 100. The charger 220 may receive the first tab 122a in the first mounting recess 223 and receive the second tab 122b in the second mounting recess 225. The fit between the mounting recesses 223, 225 and the tabs 122a and 122b may be of a sufficient tolerance, e.g., a press fit, friction fit, so as to secure the battery pack charger 220 to the caddy 100 without necessitating the selection of a battery pack charger 220 to have an outer shape or profile to frictionally engage the portions of the body 110 of the caddy 100 surrounding the bay 120.

Referring to FIGS. 13,16, 22, and 23, each cable access 126 in the body 110 of the caddy 100 is sized to accommodate the charging cord 224 of the battery pack charger 220, such that the battery pack charger 220 may be received in a respective bay 120 without peripheral portions thereof, such as the charging cord 224, protruding outwardly from the profile of the body 110. In this regard, portions of the charging cord 224 may be tucked in to the cable access 126 associated with a respective bay 120, and may be fed toward and stored in the recess 150 on the second side 107 of the body 110.

Accordingly, each cable access 126 is in communication with both of a respective bay 120 and the recess 150 to provide a path through the body 110 (e.g., so as to be at least partially defined therein or therealong) for a respective charging cord 224 of a respective battery pack charger 220. Such an arrangement allows charging cords 224 to be passed through respective cable accesses 126 to the recess 150 in an organized fashion so as to obviate a need to pass such charging cords 224 along and over the outer surface of the body 110 to reach the recess 150 and a power strip 165 held therein.

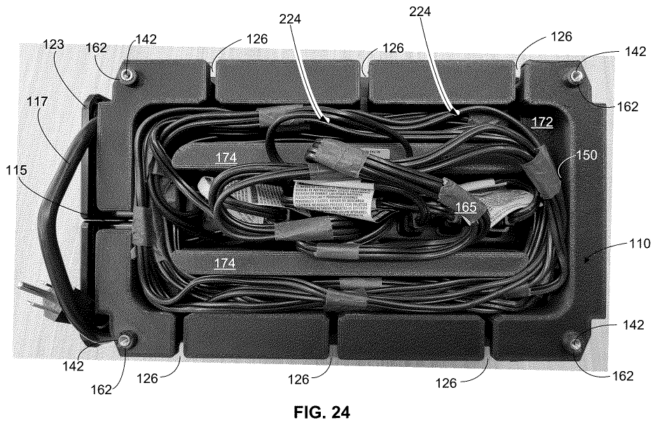

As shown in FIG. 24, the charging cords 224 may be organized in or around the recess 150, for example, by being bundled and received in the cord organizing spaces 172. In some cases, the recess 150 on the second side 107 of the body 110 are sized to accommodate the power strip 165 with one or more plugs of the battery pack charger 220 inserted therein.

FIG. 16 illustrates a bottom view of the caddy 100 of FIG. 1 with the power strip 165 in place (e.g., secured between the separation walls 174 of the body 110). As shown in FIGS. 8 and 13, the recess 150 is at least partially formed between the separation walls 174 and spaced apart from one another at a distance sufficient to fit a width of the power strip 165.

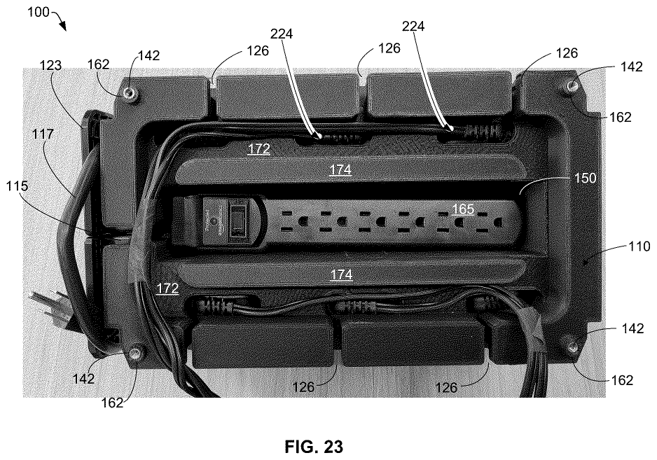

As shown in FIGS. 16, 23 and 24, the separation walls 174 further form the cord organizing spaces 172 with the body 110 for organizing the charging cords 224 of the respective battery pack chargers 220 adjacent the recess 150, for example, so that the charging cords 224 may be bundled in the cord organizing spaces 172 and fed to the power strip 165 in the recess 150.

In some cases, the power strip 165 may be attached onto the body 110 by fasteners such as clips, straps, hook and loop fasteners, adhesive tape, magnetic couplings, etc. In some embodiments, the power strip 165 may be integrated with the body 110. A common power cord 117 of the power strip 165 may be positioned passing through the side slot 115 and may be wound around the cord holder 123 so as to be disposed between the cord holder 123 and the body 110/remainder thereof to secure the common power cord 117 to the body 110 for tidiness. The power strip 165 may provide common charging outlets, including alternate current (AC) outlets matching local standards, and direct current (DC) outlets common to one or more electronic devices plugged therein.

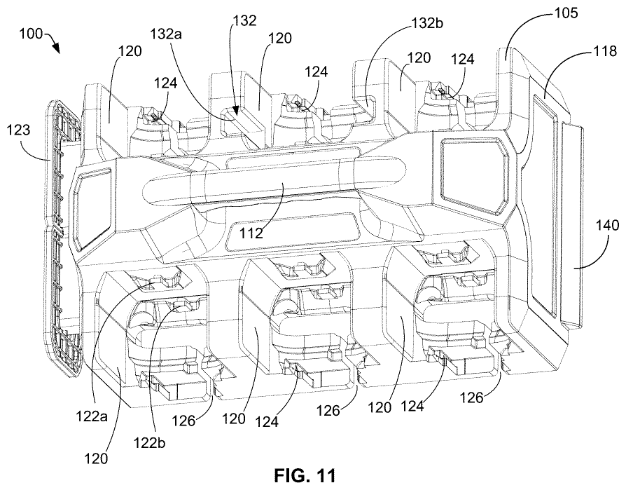

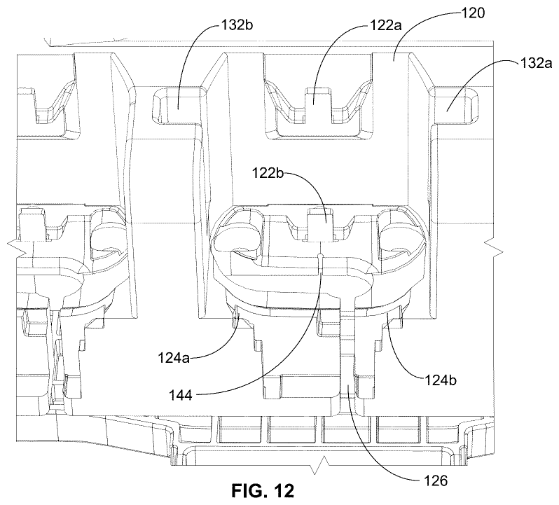

As shown in FIGS. 11 and 12, at least one of the multiple bays 120 of the caddy 100 includes a slot opening 132 (formed between the slots 132a and 132b extending outwardly from the bay 120) to receiving a mobile electronic device and a cable passthrough 144 for accommodating a charging cable for the mobile electronic device. The cable passthrough 144 may be in communication with a respective cable access 126 in the body 110 of the caddy 100. As such, the slot opening 132 may optionally be used for holding the mobile electronic device in the associated bay 120 instead of a battery pack charger 220. In some embodiments, a battery pack may be mounted to the caddy 100 at a bay 120 that includes the slot opening 132 without interfering with a placement of the mobile electronic device therein, so that the bay 120 may secure both the mobile electronic device and the battery pack for transportation.

In some embodiments, the caddy 100 may further include at least a belt mount, such as a hanger or an opening for receiving a loop, a clip, or the like. For example, one or both of the feet 140, 141 may include a flexible loop or opening for receiving belt clips. Other storage openings or compartments may be provided, such as the compartment 114 formed under the handle 112, for storing other items. In some embodiments, the one or more openings or recesses may be provided along portions of the body 110 of the caddy 100 for receiving a tool or other hardware.

Referring additionally to FIGS. 19-20, an example battery pack 305 suitable for being mounted on the caddy 100 is illustrated. The battery pack 305 is of a type that may be mated and used in combination with one or more power tools, and which may be charged by the battery pack charger 220 such as that described above. The battery pack 305 may include a battery pack housing with an upper housing portion and a lower housing portion, though it will be understood that the battery pack 305 may have a different housing configuration without departing from the disclosure.

The upper housing portion and the lower housing portion may be configured and arranged to mate together to form an interior cavity within which a set of battery cells, electronics, and other components of the battery pack 305 may be held. While the battery pack 305 may include cylindrical lithium-ion (Li-ion) battery cells, it will be understood that the battery pack 305 may include other types of battery cell chemistries and form factors without departing from the disclosure.

The battery pack 305 may also include a battery pack interface. The battery pack interface may be configured and arranged to electromechanically mate with and couple to the charger interface of the battery pack charger 220. In the example shown, the battery pack interface may include a set of slots 320 at least partially defined in the upper housing portion and a set of (or a plurality of) battery pack terminals (not shown) within the interior cavity and aligned with the set of slots. The set of battery pack terminals of the battery pack 305 is designed and configured to electromechanically mate with the correspondingly designed and configured set of battery pack charger terminals 233 of the charger interface to receive electricity for charging the power cells of the battery pack 305.

The battery pack interface may also include a set of rails 310 adjacent to and defining a respective set of channels/grooves 308. The set of rails 310 and channels 308 are configured for mechanical cooperation with the correspondingly designed set of rails 235 and channels 236 of the battery pack charger interface of the battery pack chargers 220. The rails 308 of the battery pack interface may also be configured for engaging and being received in the grooves 124 of the respective bays 120 of the caddy 100.

The battery pack interface may also include a latch 312 and an activation button 314 operably coupled to the latch 312 for facilitating engagement and withdrawal from the interface of one or more power tools.

Referring to FIGS. 1, 5, 11, and 12, the set of grooves 124, for each of the multiple bays 120, may include a pair of grooves 124a and 124b for receiving the rails 310 of the battery pack 305 to secure the battery pack 305 to the body 110/bays 120 of the caddy 100. Portions of the body 110 of the caddy 100 adjacent the grooves 124a, 124b may be received in the channels 308 of the battery pack 305 adjacent to the rails 310. In this regard, optionally, one or more battery packs 305 may be directly coupled to the body 110 of the caddy 100 at each bay 120 without a corresponding battery pack charger 220 received in the corresponding bay 120, as further illustrated in FIG. 21, in which multiple the battery packs 305 are secured directly to the caddy 100 via engagement with the grooves 124a and 124b.

FIG. 21 illustrates an isometric view of the caddy 100, with battery packs 305 received in a first subset of bays 120 and chargers 220 received in a second subset of bays 120. As shown, less than all of the available bays 120 of the caddy 100 may receive a battery pack charger 220, though all of the available bays or a different arrangement of the bays 120 may be used.

The battery pack terminals of the interface 320 of the battery pack 305 may be positioned for engagement with the charger interface of a battery pack charger 220 that is secured in the bay 120. When no battery pack charger 220 is present in a given bay 120, a battery pack 305 may be mounted to the caddy 100 by sliding the rails 310 of the battery pack 305 into the respective grooves 124, such that the channels 308 of the battery pack 305 receive a portion of the body 110 of the caddy 100 such that the battery pack 305 may be mounted on the caddy 100 at respective bays 120. In this regard, the caddy 100 may carry one or more spare battery packs 305 that are not coupled to a battery pack charger 220.

As shown in FIG. 21, the caddy 100 may be mounted to a lid 410 of a toolbox, crate, or other storage system. The lid 410 may have one or more recessed portions that present corresponding surfaces for engaging the protrusions 131 of the base plate 130. In some embodiments, such engagement could be through a snap fit.

In some embodiments, the caddy 100 may be provided without the base plate 130 (as shown in FIGS. 2 and 4-8), and enable users to fasten the body 110 to any top surfaces of preference (e.g., a top cover of any tool box), such as via the fastener openings 142.

In view of the illustrated examples in FIGS. 1-21 and the description above, the caddy 100 enables a user to organize, coordinate, and/or carry multiple battery pack chargers 220 and/or battery packs 305 conveniently. The caddy 100 arranges the battery pack chargers 220 for ease of access and transportation, and simplifies the multiple individual charging cords 224 of the battery pack chargers 220 into a common power cord 117 for the caddy 100 via the power strip 165 that may be held in the recess 150. The multiple bays 120 of the caddy 100 are versatile and configurable to additionally or alternatively hold or secure the battery packs 305, mobile electronic devices such as smartphones, and other items. The caddy 100 further provides a convenient mount option via the base plate 130, which may be locked or secured on top of matching toolboxes or crates. The handle 112 of the caddy 100 further allows a user to carry and transport multiple battery pack chargers 220 and multiple battery packs 305 in different configurations with ease.

It will be understood that one or more components of the caddy 100 and associated features may be differently configured without departing from the disclosure.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A caddy for power tool accessories, the caddy comprising:
a body forming a plurality of bays on a first side of the body, each bay of the plurality of bays (1) recessed along the first side of the body for at least partially receiving a battery pack charger, (2) including a set of protrusions for engaging the received battery pack charger, and (3) including a set of grooves for at least partially receiving a battery pack electrically chargeable by the battery pack charger; and
a recess formed on a second side of the body, the second side of the body opposite the first side of the body, the recess in communication with a plurality of cable accesses, each cable access of the plurality of cable accesses in communication with a respective bay of the plurality of bays for facilitating passage of a charging cord associated with the battery pack charger received in the respective bay.

2. The caddy of claim 1, wherein the set of protrusions comprises a plurality of tabs for being at least partially received in respective hanging features of the received battery pack charger for securing the received battery pack charger in the receiving bay of the plurality of bays.

3. The caddy of claim 2, wherein the set of grooves comprises a plurality of slots for receiving corresponding rails of the battery pack to secure the battery pack to a receiving bay of the plurality of bays.

4. The caddy of claim 1, further comprising mounting features along the second side of the body for facilitating coupling of the body to a base plate configured for engagement with a support, the mounting features comprising a plurality of fastener openings formed in the body for aligning with a plurality of fastener openings formed in the base plate.

5. The caddy of claim 1, wherein the recess on the second side of the body is arranged for at least partially receiving a power strip for being in electrical communication with the battery pack charger received in the respective bay.

6. The caddy of claim 5, further comprising:
mounting features along the second side of the body for facilitating coupling of the caddy to a support;
a handle formed on the first side of the body; and
a cord wrap for securing a power cable of the power strip to the body.

7. The caddy of claim 1, wherein at least one bay of the plurality of bays includes a slot opening for receiving a mobile electronic device and a cable passthrough for accommodating a charging cable for the mobile electronic device.

8. The caddy of claim 1, further comprising at least one of a hanger and at least one opening for securing hardware to the caddy.

9. A portable charging system for battery packs, the portable charging system comprising:
a body forming a plurality of bays on a first side of the body, each bay of the plurality of bays (1) recessed along the first side of the body for at least partially receiving a battery pack charger, (2) including a set of protrusions for engaging the battery pack charger, and (3) including a set of grooves for receiving a battery pack electrically chargeable by the battery pack charger;
a recess formed on a second side of the body, the second side of the body opposite the first side of the body, the recess in communication with a plurality of cable accesses, each cable access of the plurality of cable accesses in communication with a respective bay of the plurality of bays for facilitating passage of a charging cord associated with the battery pack charger, the recess on the second side of the body is sized to accommodate a power strip for being in electrical communication with each received battery pack charger, the body having a side slot along the second slide for receiving a power cord of the power strip.

10. The portable charging system of claim 9, wherein the set of protrusions comprises a plurality of tabs for being at least partially received in respective hanging features of the battery pack charger for securing the battery pack charger in a receiving bay of the plurality of bays.

11. The portable charging system of claim 10, wherein the set of grooves are configured for receiving corresponding rails in the battery pack to secure the battery pack to a receiving bay of the plurality of bays.

12. The portable charging system of claim 9, further comprising mounting features along the second side of the body for facilitating coupling of the portable charging system to a support.

13. The portable charging system of claim 12, wherein the mounting features are configured for coupling the body to a base plate configured for engagement with the support, the mounting features comprising a plurality of fastener openings formed in the body for aligning with a plurality of fastener openings formed in the base plate.

14. A mountable battery pack organizer, comprising:
a body forming a plurality of bays on a first side of the body, each bay of the plurality of bays (1) recessed along the first side of the body for at least partially receiving a battery pack charger (2) including a set of protrusions for engaging the received battery pack charger, and (3) including a set of grooves for receiving a battery pack chargeable by the battery pack charger.

15. The mountable battery pack organizer of claim 14, wherein the set of grooves are configured for receiving corresponding rails in the battery pack to secure the battery pack to a receiving bay of the plurality of bays.

16. The mountable battery pack organizer of claim 15, wherein the set of protrusions comprises a plurality of tabs for being at least partially received in a hanging feature of the received battery pack charger for securing the battery pack charger in the receiving bay of the plurality of bays.

17. The mountable battery pack organizer of claim 14, further comprising a recess in communication with a plurality of cable accesses, each cable access of the plurality of cable accesses in communication with a respective bay of the plurality of bays for facilitating passage of a charging cord associated with the battery pack charger received in the respective bay, each cable access of the plurality of cable accesses is sized to accommodate a charging cord of the battery pack charger to be received in a corresponding bay of the plurality of bays, the recess on the second side of the body arranged for at least partially receiving a power strip for being in electrical communication with the respective battery pack charger.

18. The mountable battery pack organizer of claim 17, further comprising:
mounting features along the second side of the body for facilitating coupling of the mountable battery pack organizer to a support;
a handle formed on the first side of the body; and
a cord wrap for securing a power cable of the power strip to the body.

19. The mountable battery pack organizer of claim 14, wherein at least one bay of the plurality of bays includes a slot opening for receiving a mobile electronic device and a cable passthrough for accommodating a charging cable for the mobile electronic device.

20. The mountable battery pack organizer of claim 14, wherein each bay of the plurality of bays is shaped for receiving the battery pack charger being selected from a set of multiple differently-configured battery pack chargers.
